(19) United States
(12) Patent Application Publication
(10) Pub. No.: US 2004/0048649 A1
(43) Pub. Date: Mar. 11, 2004

(54) Gaming device having a bonus game with multiple player selectable award opportunities

(76) Inventors: Tonja M. Peterson, Reno, NV (US); Dov L. Randall, Whitefield (GB); Peter Gerrard, Prestwich (GB); Anthony J. Baerlocher, Reno, NV (US); Peter J. A. Marsh, Lancashire (GB)

Correspondence Address: BELL, BOYD & LLOYD LLC, P. O. BOX 1135, CHICAGO, IL, 60690-1135, US

(21) Appl. No.: 10/237,207

(22) Filed: Sep. 6, 2002

(51) Int. Cl. A63F 13/00

(52) U.S. Cl. 463/20

(57) ABSTRACT

A gaming device and method having a game with multiple player selectable award opportunities. In one embodiment, the gaming device displays a plurality of groups to a player. Each of the groups include related award opportunities. An indicator simultaneously indicates at least two of the award opportunities in one of the groups. The player chooses one of the indicated award opportunities and receives the outcome which results from the indicated award opportunity picked by the player. In one embodiment, the average expected values of the outcomes which result from the indicated award opportunities in each group are approximately equal.

### COPYRIGHT NOTICE

A portion of the disclosure of this patent document contains or may contain material, which is subject to copyright protection. The copyright owner has no objection to the photocopy reproduction by anyone of the patent document or the patent disclosure in exactly the form it appears in the Patent and Trademark Office patent file or records, but otherwise reserves all copyright rights whatsoever.

### BACKGROUND OF THE INVENTION

The present invention relates to the gaming device having a bonus event and specifically, to a bonus event with multiple player selectable award opportunities.

Gaming device manufacturers strive to make gaming devices that provide as much enjoyment and excitement as possible. Providing a secondary or bonus game which a player has an opportunity to win potentially large awards or credits in addition to the awards associated with the primary or base game of the gaming device is one known method for enhancing player enjoyment and excitement.

Gaming devices having bonus games generally employ a triggering event that occurs during the operation of the base game of the gaming device. The triggering event temporary stalls or halts the base game play and enables a player to enter a second, different game, which is the secondary or bonus game. The player plays the bonus game, likely receives an award, and returns to the base game.

Bonus games exist that display multiple selections or options to a player. The player picks one of the options to obtain an award in the bonus game. Thus, the player's award depends on which option the player selects in the bonus game. One such bonus game is included in the “Jazzy Jackpots™” gaming device manufactured by Atronic Americas, LLC. In this game, the gaming device displays five reels to a player. Each reel includes several symbols including a coin symbol having a sun pattern on one side of the coin symbol. When three or more coin symbols occur in any position on the reels, the coin symbols begin to flip or turn. If three or more coin symbols display the sun pattern when the coin symbols stop flipping, the gaming device initiates the Jazzy Jackpots™ bonus game or secondary game. In the bonus game, the gaming device displays two predetermined options to the player. One option includes a video of a wheel, which the player spins to obtain free spins of the reels in the primary game and a multiplier. The other option is a video of an antique slot machine having a set of three reels where the player spins the reels to obtain credits. The player is provided with five free spins of the reels. The player spins the reels to obtain credits, which are multiplied by a multiplier based on the player's wager. The player chooses one of these two games to obtain an award in the bonus game. Thus, the player receives either free spins or credits depending on the particular game selected by the player in the bonus game.

Gaming devices that increase the opportunities to obtain awards and increase the size of the awards are desirable. Additionally, gaming devices that enable players to choose between different award selections or options increases the player's excitement and enjoyment of the game. Players are attracted to games that provide additional awards and different options to the player. Therefore, to increase player enjoyment and excitement, it is desirable to provide new games for gaming devices.

### SUMMARY OF THE INVENTION

The present invention is directed to a gaming device having a bonus game and specifically, a gaming device having a bonus game with multiple player selectable award opportunities. The award opportunities may provide predetermined or randomly determined outcomes. In one preferred embodiment, the award opportunities are divided or grouped in groups such as pairs of award opportunities, which are related to one another. In this embodiment, a processor randomly selects and causes an indicator to indicate one of the groups such as a pair of award opportunities. A player then chooses one of the award opportunities in the indicated group to obtain the award opportunity and receive the outcome associated with the selected award opportunity. The outcome may be a value provided to the player or it may not have a value. Therefore, the player picks one of the indicated award opportunities and receives the value of the outcome, if any, associated with that award opportunity. If the player receives an award, which results from the picked award opportunity, the award is added to the player's total award in the game. In one embodiment, the outcomes of the award opportunities in the group or pair of award opportunities each have approximately the same average expected value.

In another embodiment, the average expected values of the outcomes for the award opportunities in a group are different. Therefore, the player attempts to pick the award opportunity from the group of award opportunities that generates the higher average expected value. In one embodiment, when the player picks the award opportunity including the lower average expected value, the gaming device determines the difference between the average expected values of the two award opportunities in the group and transfers the value difference to a progressive jackpot or award. The gaming device provides the progressive jackpot to a player when a triggering event occurs in the game. In one embodiment, the triggering event includes a progressive award opportunity, symbol or combination of symbols being indicated by the indicator. In another embodiment, the processor automatically picks the progressive award opportunity when a particular award opportunity or group of award opportunities are indicated by the indicator.

In one embodiment, a probability of being indicated by the indicator is associated with each group of the award opportunities in the game. In one embodiment, the average expected values of the outcomes associated with at least one group of the award opportunities are relatively large values. In this embodiment, a probability of being indicated is associated with each of the award opportunities having the outcomes with relatively large average expected values such that the probability of being indicated associated with the award opportunities having outcomes with relatively large average expected values is less than the probabilities of being indicated associated with the other award opportunities having outcomes with smaller average expected values. In another embodiment, the probability of being indicated associated with the award opportunities vary inversely with the average expected values of the outcomes associated with the award opportunities.

In one embodiment, a mechanical wheel having a plurality of sections is displayed to a player. Groups of opportunities are associated with the sections on the wheel. The groups include related award opportunities, which are positioned on opposing sections of the wheel. An indicator simultaneously indicates two of the sections having related award opportunities. The player chooses one of the indicated award opportunities associated with the indicated sections on the wheel. The player then receives the outcome which results from the picked award opportunity. The outcome may or may not provide an award to the player. Thus, the player receives the award or value, if any, from the outcome of the award opportunity picked by the player and the game ends.

The groups, such as groups including pairs of related award opportunities, could be arranged or displayed in any suitable manner. In one embodiment, for instance, the award opportunities are arranged in two groups such as columns. Each column includes several sections and each section includes an award opportunity. An indicator is positioned between the columns and simultaneously indicates one of the sections in each column. The player picks one of the two award opportunities associated with the indicated sections on the wheel. The player receives the outcome, which results from the award opportunity picked by the player.

Although the present invention is primarily discussed relative to a bonus game of a gaming device, it should be appreciated that the present invention could be employed as a primary game in a gaming device. In one embodiment of a primary game, groups of award opportunities are displayed to the player. The award opportunities include several related pairs of bonus events such as bonus games. The indicator indicates two of the bonus games in one of the groups and the player picks one of the indicated bonus games. The player receives the value, if any, of the outcome, which results from the picked bonus game. It should be appreciated that the award opportunities in the primary game may include any suitable types of award opportunities.

In another embodiment, the award opportunities include several bonus events where at least one of the award opportunities in each group of award opportunities includes a bonus event. In this embodiment, the bonus events are bonus games selected from one or more groups of bonus games. A probability of being selected by the processor is associated with each of the bonus games in the groups. In one embodiment, the processor selects a bonus game from one group of bonus games based on the probabilities when an award opportunity including a bonus game symbol is indicated by the indicator. In another embodiment, the processor selects the bonus game from a plurality of groups of bonus games based on the probabilities. In a further embodiment, the probabilities associated with each of the bonus games in the groups change after each bonus game is indicated by the indicator. In another embodiment, the probabilities associated with each of the bonus games in the groups change after a plurality of bonus games are indicated by the indicator. It should be appreciated that the probabilities associated with each of the bonus games may change after one or more bonus game symbols are indicated by the indicator.

It is therefore an advantage of the present invention to provide a gaming device having a bonus event with multiple player selectable award opportunities where the player chooses between at least two indicated award opportunities.

Another advantage of the present invention is to provide more award opportunities to players to increase player excitement and entertainment.

Other objects, features and advantages of the invention will be apparent from the following detailed disclosure, taken in conjunction with the accompanied sheets and drawings, wherein like numerals refer to like parts, elements, components, steps and processes.

### BRIEF DESCRIPTION OF THE FIGURES

FIG. 1A is a front perspective view of one embodiment of the gaming device of the present invention.

FIG. 1B is a front perspective of another embodiment of the gaming device of the present invention.

FIG. 2 is a schematic block diagram of the electronic configuration of one embodiment of the gaming device of the present invention.

FIG. 3 is an enlarged front elevation view of one of the display devices of FIGS. 1A and 1B illustrating one embodiment of the present invention.

FIG. 4 is an enlarged front elevation view of one of the display devices of FIGS. 1A and 1B illustrating an example of the embodiment of FIG. 3 where two award opportunities are indicated on the wheel.

FIGS. 5A and 5B are enlarged front elevation views of one of the display devices of FIGS. 1A and 1B illustrating two different bonus events which may be initiated when the player chooses one of the indicated award opportunities in FIG. 4.

FIG. 6 is an enlarged front elevation view of one of the display devices of FIGS. 1A and 1B illustrating one embodiment of a bonus event such as a bonus game that is initiated when the player chooses the other indicated award opportunity in FIG. 4.

FIG. 7 is an enlarged front elevation view of one of the display devices of FIGS. 1A and 1B illustrating an alternative embodiment of the present invention.

### DETAILED DESCRIPTION OF THE INVENTION

### Gaming Device and Electronics

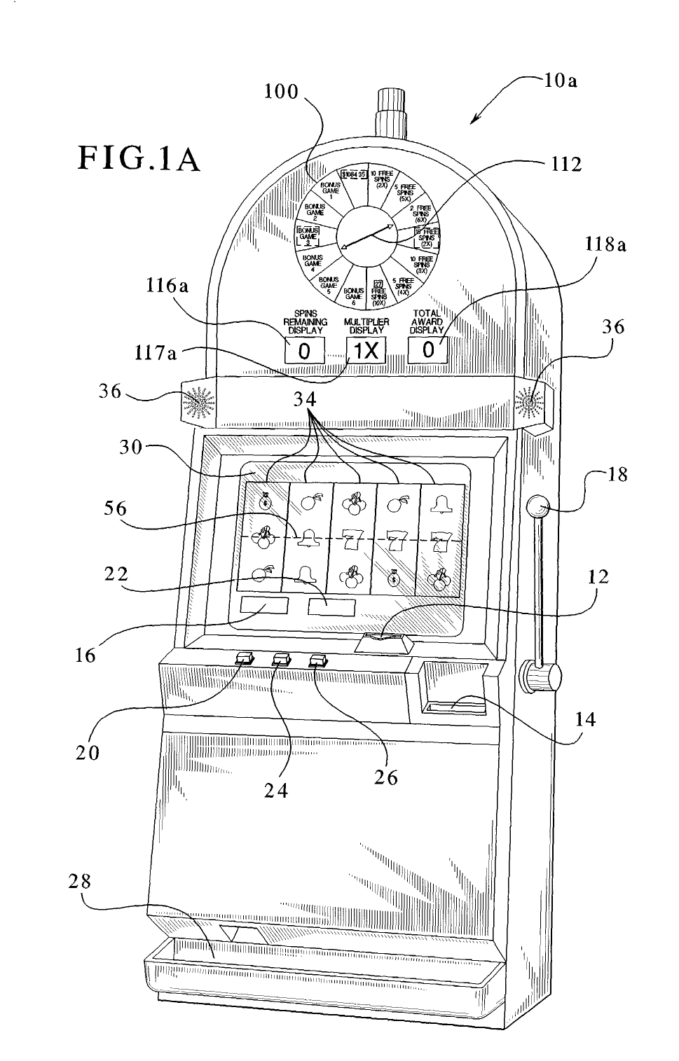

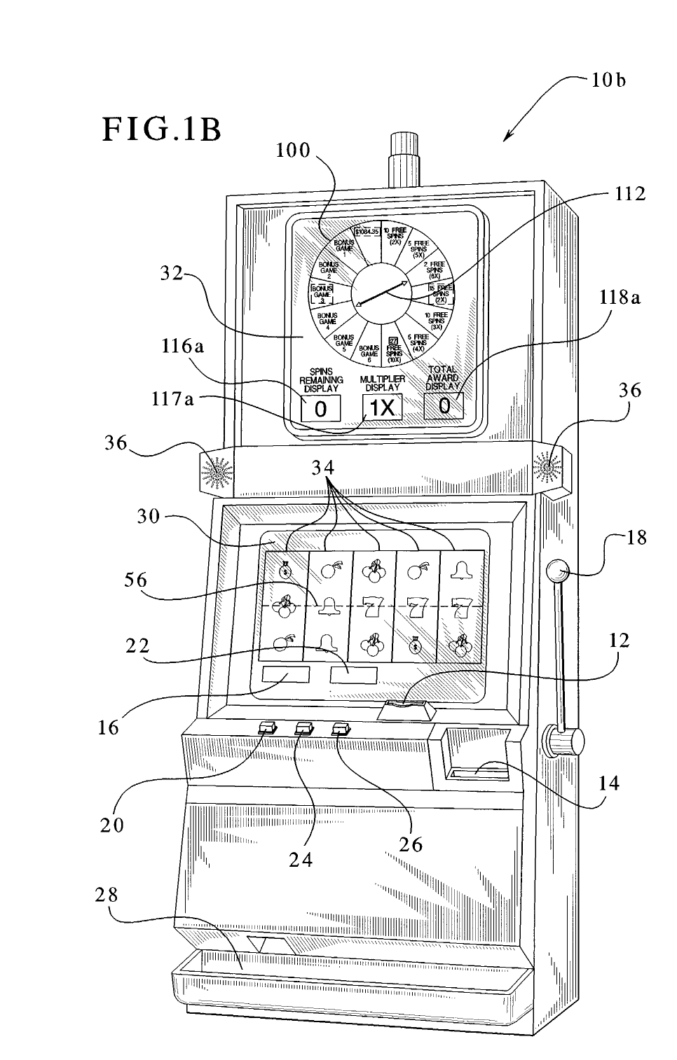

Referring now to the drawings, two embodiments of the gaming device of the present invention are illustrated in FIGS. 1A and 1B as gaming device 10a and gaming device 10b, respectively. Gaming device 10a and/or gaming device 10b are generally referred to herein as gaming device 10. Gaming device 10 in one embodiment has the controls, displays and features of a conventional slot machine. It is constructed so that a player can operate it while standing or sitting, and gaming device 10 is preferably mounted in a cabinet. However, it should be appreciated that gaming device 10 can be constructed as a pub-style table-top game (not shown) which a player can operate preferably while sitting. Furthermore, gaming device 10 can be constructed with varying cabinet and display designs, as illustrated by the designs shown in FIGS. 1A and 1B. Gaming device 10 can also be implemented as a program code stored in a detachable cartridge for operating a hand-held video game device. Also, gaming device 10 can be implemented as a program code stored on a disk or other memory device which a player can use in a desktop or laptop personal computer or other computerized platform.

Gaming device 10 can incorporate any primary game such as slot, poker, blackjack or keno, and any of the bonus triggering events and bonus games associated with these primary games. The symbols and indicia used on and in gaming device 10 may be in mechanical, electrical, electronic or video form.

As illustrated in FIGS. 1A and 1B, gaming device 10 includes a coin slot 12 and bill acceptor 14 where the player inserts money, coins or tokens. The player can place coins in the coin slot 12 or paper money or ticket vouchers in the bill acceptor 14. Other devices could be used for accepting payment such as readers or validators for credit cards or debit cards. When a player inserts money in gaming device 10, a number of credits corresponding to the amount deposited is shown in a credit display 16. After depositing the appropriate amount of money, a player can begin the game by pulling arm 18 or pushing play button 20. Play button 20 can be any play activator used by the player which starts any game or sequence of events in the gaming device.

As shown in FIGS. 1A and 1B, gaming device 10 also includes a bet display 22 and a bet one button 24. The player places a bet by pushing the bet one button 24. The player can increase the bet by one credit each time the player pushes the bet one button 24. When the player pushes the bet one button 24, the number of credits shown in the credit display 16 decreases by one, and the number of credits shown in the bet display 22 increases by one. Other bet or wager indicators such as a bet max button may also be employed in the gaming device of present invention.

A player may cash out and thereby receive a number of coins corresponding to the number of remaining credits by pushing a cash out button 26. When the player cashes out, the player receives the coins in a coin payout tray 28. The gaming device 10 may employ other payout mechanisms such as credit slips redeemable by a cashier or electronically recordable cards which keep track of the player's credits.

Gaming device 10 also includes one or more display devices. The embodiment shown in FIG. 1A includes a central display device 30 and a mechanical wheel 100, and the alternative embodiment shown in FIG. 1B includes a central display device 30 as well as an upper display device 32, which includes a video image of the wheel 100. Gaming device 10 in one embodiment displays a plurality of reels 34 such as three to five reels 34 in mechanical or video form at one or more of the display devices. However, it should be appreciated that the display devices can display any visual representation or exhibition, including but not limited to movement of physical objects such as mechanical reels and wheels, dynamic lighting and video images. A display device can be any viewing surface such as glass, a video monitor or screen, a liquid crystal display or any other display mechanism. If the reels 34 are in video form, the display device for the video reels 34 is preferably a video monitor. Each reel 34 displays a plurality of indicia such as bells, hearts, fruits, numbers, letters, bars or other images which preferably correspond to a theme associated with the gaming device 10. Furthermore, gaming device 10 preferably includes speakers 36 for producing sounds such as music.

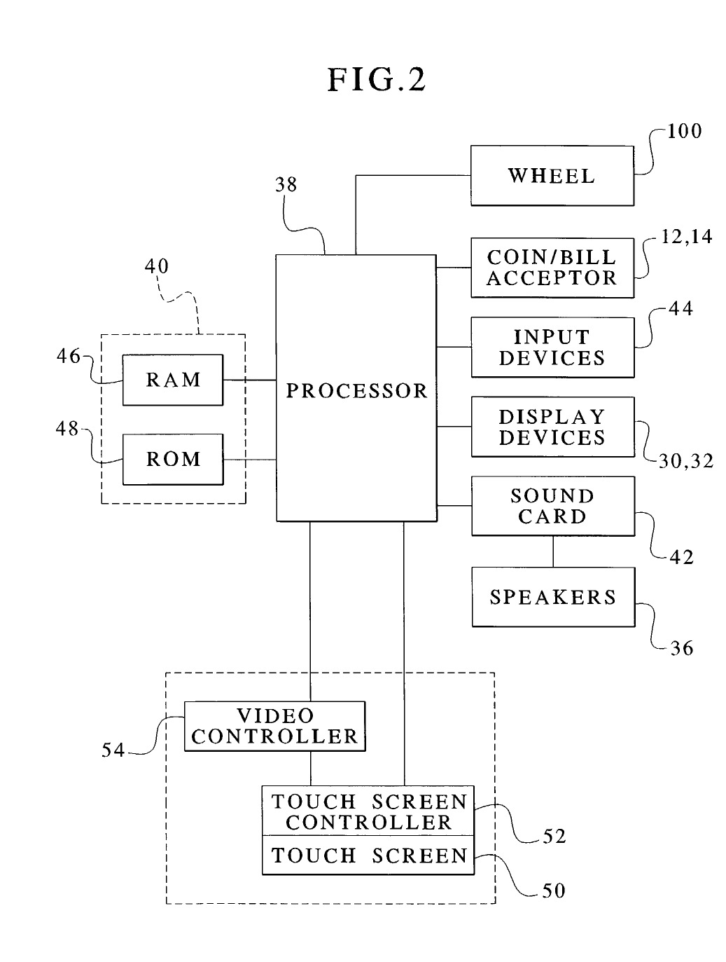

As illustrated in FIG. 2, the general electronic configuration of gaming device 10 preferably includes: a processor 38; a memory device 40 for storing program code or other data; a central display device 30; an upper display device 32; a wheel 100; a sound card 42; a plurality of speakers 36; and one or more input devices 44. The processor 38 is preferably a microprocessor or microcontroller-based platform which is capable of displaying images, symbols and other indicia such as images of people, characters, places, things and faces of cards. One or more secondary processors may also be employed in conjunction with the primary processor to control certain aspects of the game function. The memory device 40 can include random access memory (RAM) 46 for storing event data or other data generated or used during a particular game. The memory device 40 can also include read only memory (ROM) 48 for storing program code which controls the gaming device 10 so that it plays a particular game in accordance with applicable game rules and pay tables.

As illustrated in FIG. 2, the player preferably uses the input devices 44, such as pull arm 18, play button 20, the bet one button 24 and the cash out button 26 to input signals into gaming device 10. In certain instances it is preferable to use a touch screen 50 and an associated touch screen controller 52 instead of a conventional video monitor display device. Touch screen 50 and touch screen controller 52 are connected to a video controller 54 and processor 38. A player can make decisions and input signals into the gaming device 10 by touching touch screen 50 at the appropriate places. As further illustrated in FIG. 2, the processor 38 can be connected to coin slot 12 or bill acceptor 14. The processor 38 can be programmed to require a player to deposit a certain amount of money in order to start the game.

It should be appreciated that although a processor 38 and memory device 40 are preferable implementations of the present invention, the present invention can also be implemented using one or more application-specific integrated circuits (ASIC's) or other hard-wired devices, or using mechanical devices (collectively or alternatively referred to herein as a “processor”). Furthermore, although the processor 38 and memory device 40 preferably reside on each gaming device 10 unit, it is possible to provide some or all of their functions at a central location such as a network server for communication to a playing station such as over a local area network (LAN), wide area network (WAN), Internet connection, microwave link, and the like. The processor 38 and memory device 40 are generally referred to herein as the “computer” or “controller.”

With reference to FIGS. 1A, 1B and 2, to operate the gaming device 10, in one embodiment the player must insert the appropriate amount of money or tokens at coin slot 12 or bill acceptor 14 and then pull the arm 18 or push the play button 20. The reels 34 will then begin to spin. Eventually, the reels 34 will come to a stop. As long as the player has credits remaining, the player can spin the reels 34 again. Depending upon where the reels 34 stop, the player may or may not win additional credits.

In addition to winning credits in this manner, in one embodiment gaming device 10 also gives players the opportunity to win credits in a bonus round. This type of gaming device 10 will include a program which will automatically initiate a bonus round when the player has achieved a qualifying condition in the game. This qualifying condition can be a particular arrangement of indicia on a display device. The gaming device 10 may use mechanical devices or a video-based central display device 30 to enable the player to play the bonus round. In one embodiment, the qualifying condition is a predetermined combination of indicia appearing on a plurality of reels 34. As illustrated in the five reel slot game shown in FIGS. 1A and 1B, the qualifying condition could be the number seven appearing on three adjacent reels 34 along a payline 56. It should be appreciated that the present invention can include one or more paylines, such as payline 56, wherein the paylines can be horizontal, diagonal or any combination thereof.

### Bonus Game

In one embodiment of the present invention, if a player achieves a bonus triggering or qualifying condition during the primary game, the gaming device 10 initiates the secondary or bonus game of the present invention.

The bonus game of the present invention includes a game having multiple player selectable award opportunities. The award opportunities may be any suitable award opportunities including but not limited to bonus games, predetermined awards, randomly determined awards, progressive awards, progressive numbers of free spins, free spins or free games in a primary game, free spins or free games in bonus game, or modifiers such as multipliers. In one presently preferred embodiment, the award opportunities are grouped or divided into groups of related award opportunities. Each group may include one or more of the related award opportunities and the award opportunities are related in any suitable manner. The award opportunities may provide predetermined or randomly determined outcomes. The outcomes may include awards, values, free spins, free games, progressive awards, progressive numbers of free spins, modifiers such as multipliers or credits. It should be appreciated that the outcomes do not have to be associated with an award or value. Accordingly, some of the outcomes do not have a value or produce a zero value.

In one embodiment, the award opportunities are grouped into pairs of related award opportunities where at least one outcome is associated with each award opportunity. An indicator indicates one of the groups of related award opportunities. A player then chooses or picks one of the award opportunities in the indicated group and receives the outcome associated with the picked award opportunity. The outcome may be an award such as a value or credit, or no award or value.

In one embodiment, the indicator simultaneously indicates pairs of related award opportunities. In one embodiment, the related award opportunities are positioned opposite to each other. In another embodiment, the related award opportunities are positioned adjacent to each other. An indicator simultaneously indicates one of the related pairs of award opportunities. In another embodiment, separate indicators independently indicate the pair of related award opportunities. After one of the pairs of award opportunities are indicated by the indicator, the player chooses one of the two award opportunities in the indicated pair of award opportunities. Then the player receives the outcome associated with or which results from the indicated award opportunity picked by the player.

In the presently preferred embodiment, the outcomes with result from the indicated award opportunities include an expected value or values. The expected value of the outcome varies and depends on the type of award opportunity which produces the particular outcome. In one embodiment, the average expected values of the outcomes which result from the indicated award opportunities are approximately equal. Therefore, the player will receive approximately the same expected value for either of the outcomes associated with the indicated award opportunities regardless of which award opportunity is picked by the player.

In another embodiment, the average expected values of the outcomes which result from the indicated award opportunities are different. In this embodiment, the player chooses one of the award opportunities from the indicated pair of award opportunities. If the picked award opportunity includes a greater average expected value that the non-picked award opportunity, the gaming device provides the value associated with the picked award opportunity. If the unpicked award opportunity includes the greater average expected value (i.e., an incorrect choice), the amount of the difference between the average expected values is credited or transferred to a progressive jackpot or award. The progressive jackpot or award increases until the gaming device indicates the progressive award symbol.

In a further embodiment, the processor selects a bonus event such as a bonus game associated with an indicated pair of award opportunities based on a probability of being selected by the processor associated with each award opportunity. In one embodiment, the processor selects one bonus game from a group of bonus games based on the probabilities. In another embodiment, the processor selects the bonus game from at least two groups of bonus games, where a probability of being indicated is associated with each of the bonus games in the groups. In a further embodiment, the probabilities associated with the bonus games in the groups change after each selection in an indicated group by the player. In another embodiment, the probabilities associated with the bonus games in the groups change after a plurality of selections from the groups. It should be appreciated that the indicated bonus game may be selected from one or more groups of bonus games based on the probabilities.

In one embodiment, the expected values of the outcomes which result from the indicated award opportunities vary based on the desires of the game implementor. Thus, a probability of being indicated by the indicator is associated with each of the pairs of award opportunities. In one embodiment, one pair of award opportunities includes outcomes which have higher average expected values than another pair or pairs of award opportunities. In this embodiment, the probability of being indicated associated with that pair of award opportunities having the greater average expected value is higher than the probability of being indicated associated with the other pairs of award opportunities. In another embodiment, the probability of being indicated associated with the award opportunities vary inversely with the average expected values of the outcomes associated with the award opportunities. Therefore, the greater the average expected values of the outcomes associated with the award opportunities, the lower the probabilities of being indicated associated with those award opportunities.

In one alternative embodiment, the award opportunities are arranged in two separate groups such as columns. The groups or columns include several sections wherein each section includes an award opportunity. The award opportunities are preferably related such that the sections including related award opportunities are positioned opposite to each other in the columns or groups. An indicator is positioned between the groups or columns and simultaneously indicates one of the sections in each of the groups or columns. It should be appreciated that the pairs of award opportunities may be related in any suitable manner.

In another alternative embodiment, the present invention is employed in a primary game, where the award opportunities are a plurality of bonus events or bonus games. The bonus games or award opportunities are related such that pairs of related bonus games are positioned opposite to each other. An indicator simultaneously indicates one of the pairs of bonus events or games. The player then picks one of the bonus games in the pair of indicated bonus games. The bonus game picked by the player is initiated and the player receives the outcome associated with that bonus game. In one embodiment, the average expected values of the outcomes associated with the bonus games are approximately equal. Therefore, the player will receive approximately the same average value from the bonus games regardless of which bonus game is picked by the player.

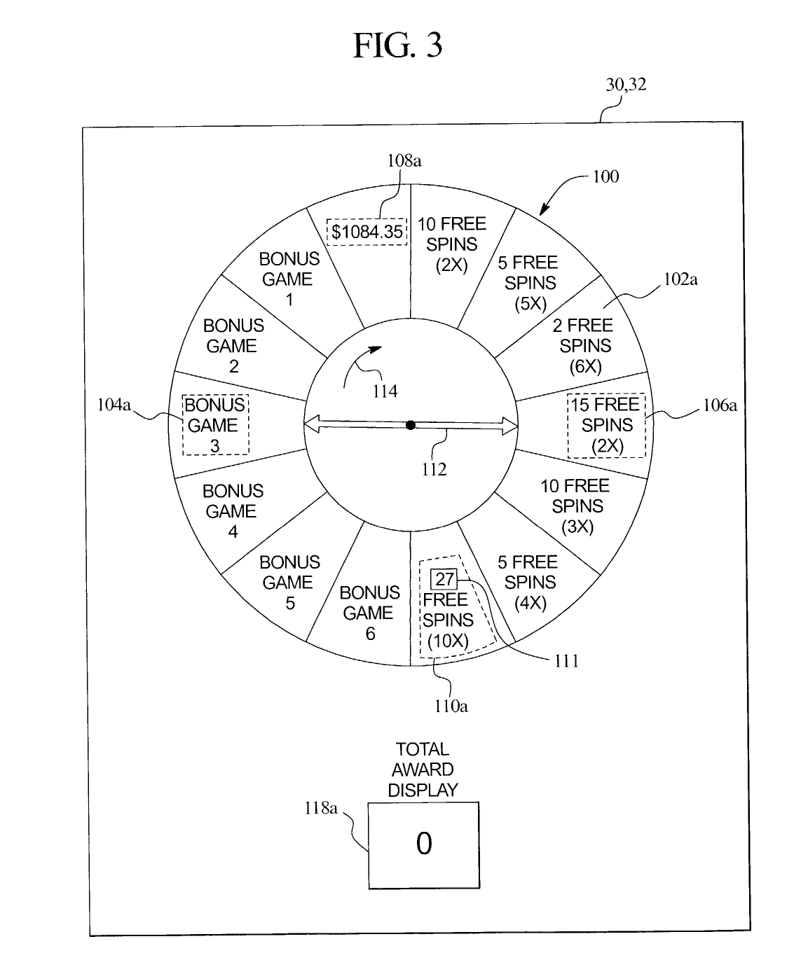

Referring now to FIG. 3, one embodiment of the present invention is illustrated where the bonus game includes a wheel 100 having a plurality of sections 102a. A plurality of groups of award opportunities are associated with the sections 102a on the wheel. The groups of award opportunities are positioned on the wheel so that related award opportunities in the groups are positioned opposite to each other on the wheel. An indicator 112 indicates one of the groups or pairs of related award opportunities in each spin.

In the illustrated embodiment, the award opportunities include a plurality of bonus game symbols 104a and a plurality of opportunities in a sub-game such as a subsequent bonus game. Additionally, one of the award opportunities includes a progressive award 108a and another of the award opportunities 110a associated with the sub-game includes a progressive number of free spins 111 and a multiplier.

An indicator 112 is rotatably connected to the gaming device in the center of the wheel 100. The indicator 112 rotates in a clockwise direction as indicated by arrow 114 and simultaneously indicates two award opportunities or one pair of award opportunities associated with the sections 102a on the wheel. In this embodiment, the indicator 112 is a single indicator that simultaneously indicates two of the sections on the wheel. The indicator 112 may rotate in a clockwise direction, counter-clockwise direction, or any combination of clockwise and counter-clockwise directions. Also, in this embodiment the wheel 100 remains stationary while the indicator 112 rotates to indicate sections on the wheel. In another embodiment, the indicator 112 remains stationary while the wheel 100 rotates. It should be appreciated that the wheel may rotate, the indicator may rotate, or both the wheel and indicator may rotate in the same direction or in different directions. A total award display 118a indicates the total award accumulated by the player in the bonus game. The award indicated in the total award display at the end of the bonus game is the award provided to the player.

Referring to FIG. 3, the award opportunities including bonus game symbols 104a are positioned opposite to the award opportunities including opportunities in the sub-game 106a. Thus, the indicator 112 indicates one bonus event or bonus game symbol 104a and one of the opportunities in the sub-game 106a. It should be appreciated that the award opportunities may be positioned in any suitable manner desired by the game implementor. In one embodiment described above, the average expected values of the outcomes which result from the indicated award opportunities are equal or approximately equal.

For example, the average expected value of the outcome which results from the award opportunity including the progressive award 108a is approximately equal to the average expected value of the outcome which results from the award opportunity having the opportunity in the sub-game 110a. Therefore, if the player picks the indicated progressive award 108a, the player receives the outcome from that award which is the progressive award value of $1,084.35. If the player picks the opportunity in the sub-game 110a, the player receives a progressive number of free spins 111 (i.e., 27 free spins) and a “10×” multiplier to be used by the player in the sub-game. The player then uses the free spins and multiplier in the sub-game to obtain an outcome from the sub-game. The outcome may be any suitable award or no award. However, since the average expected value of the outcome from the sub-game is approximately equal to the outcome from the progressive award (i.e., $1,084.35), the average expected value of the outcome which results from the sub-game is approximately equal to $1,084.35. As a result, the player receives approximately the same average expected value regardless of which indicated award opportunity the player picks in the bonus event. Preferably, the player does not know that the average expected values of the outcomes which result from the indicated award opportunities are approximately equal.

Referring to FIG. 3, if the player chooses the award opportunity including the bonus game symbol, the gaming device initiates the bonus event or game associated with that symbol. The player plays the bonus event or bonus game and receives the value of the outcome which results from that bonus event. If the player picks the award opportunity including the opportunity in the sub-game 106a, the player obtains the outcome which results from the sub-game. In this particular embodiment, the player receives a number of free spins and a multiplier to use in the sub-game. The player receives the value of the outcome, if any, which results from using the free spins and the multiplier in the sub-game.

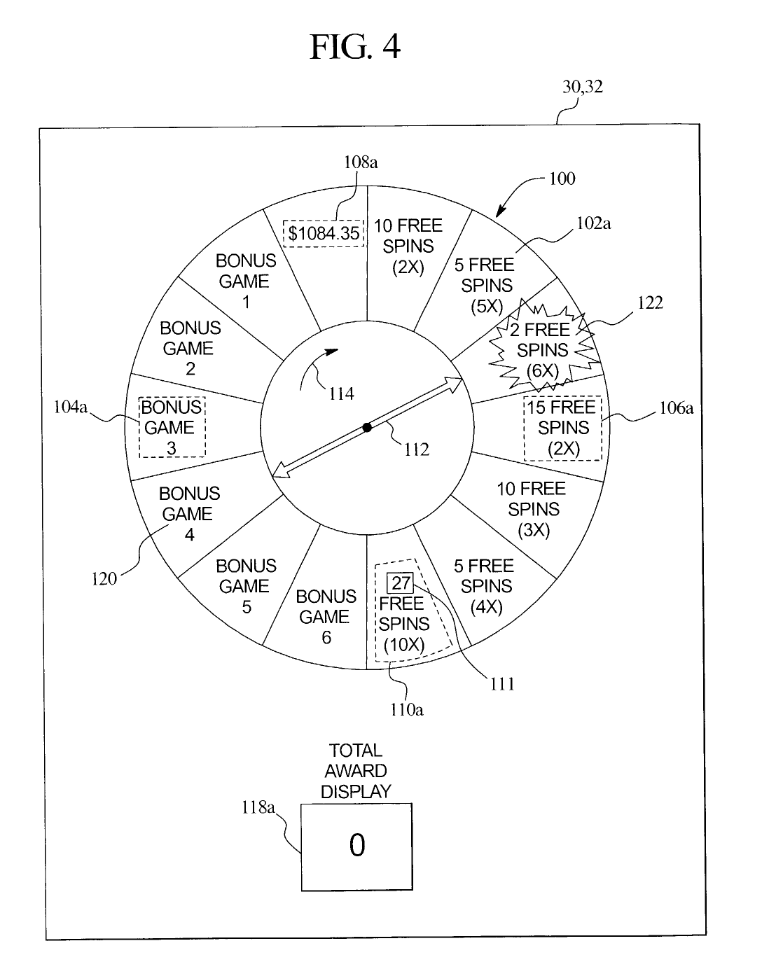

Referring now to FIG. 4, an example of the embodiment of FIG. 3 is illustrated where the bonus event or bonus game is initiated or triggered from the primary game. In FIG. 4, the gaming device or the player spins the indicator 112 to indicate sections on the wheel 100. The indicator stops and simultaneously indicates two related award opportunities in one of the groups of award opportunities. One of the indicated award opportunities in the group includes a bonus game symbol which initiates BONUS GAME 4 (120) if the player picks this award opportunity. The other indicated award opportunity in the group provides an opportunity in a sub-game. Specifically, the gaming device provides two free spins and a “6×” multiplier for the player to use in the sub-game. The player uses the spins and multiplier in the sub-game to obtain an outcome from the sub-game. In FIG. 4, the player picks the award opportunity 122, which provides the player with an opportunity in the sub-game. In this example, the award opportunity 122 initiates a sub-game where the player uses the two free spins and “6×” to obtain an outcome which results from the sub-game.

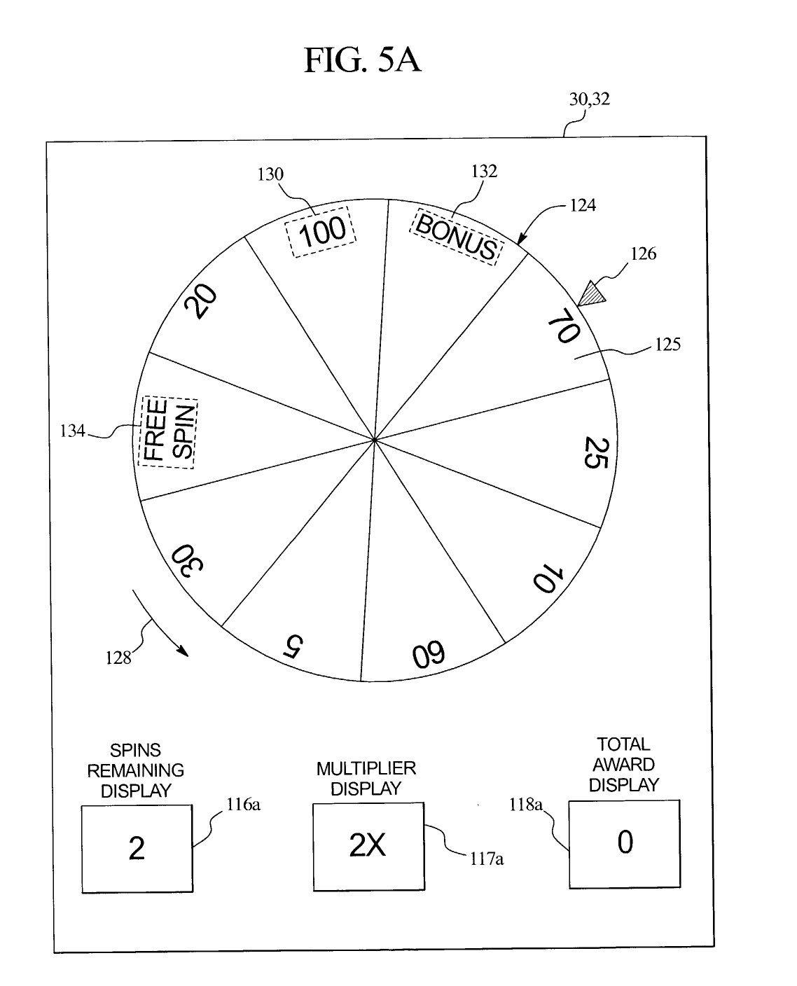

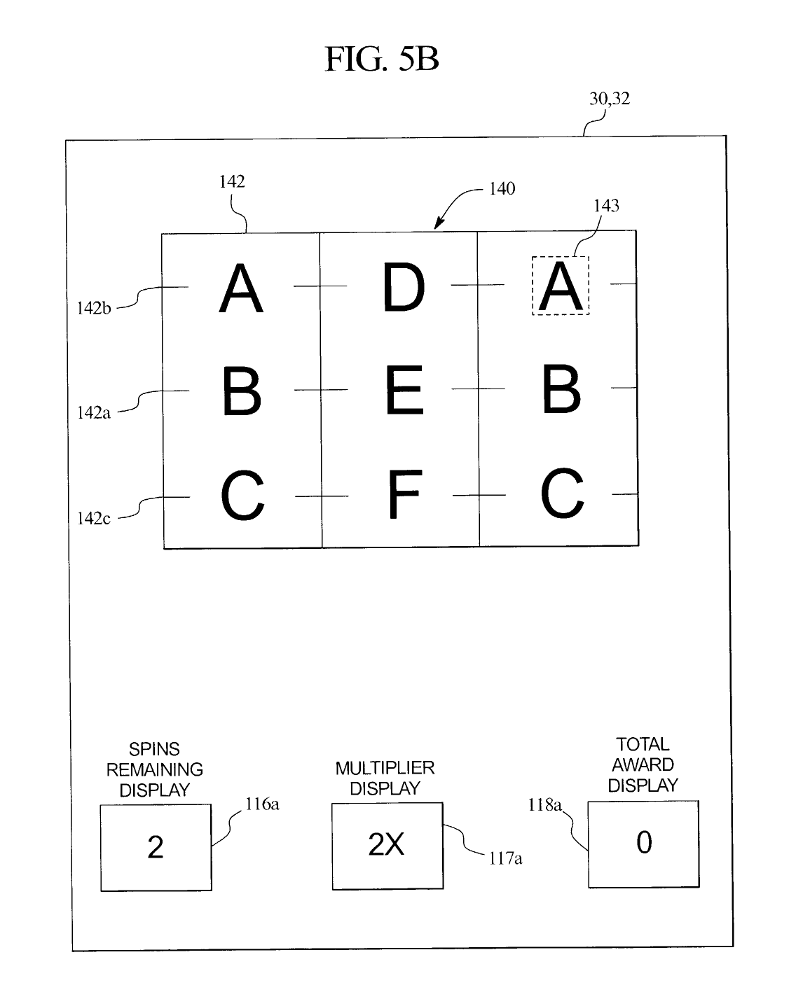

Referring to FIG. 5A, the sub-game is illustrated where the player receives the two free spins as indicated in the spins remaining display 116a and the “2×” multiplier as indicated by the multiplier display 117a. The gaming device displays a wheel 124 including a plurality of sections 125. The sections on the wheel include award symbols 130, a bonus symbol 132, and a free spin symbol 134. A plurality of awards are associated with the award symbols 130. An indicator 126 indicates sections on the wheel 124. In this embodiment, the wheel 124 spins in a counter-clockwise direction as indicated by arrow 128. The player uses the free spins to spin the wheel 124 and obtain an outcome. The indicated awards in each spin are multiplied by the multiplier indicated in multiplier display 117a. The multiplied award is then transferred to the total award display 118a. The player spins the wheel 124 until the player does not have any spins remaining in the game. The player then receives the total award indicated in the total award display 118a as the outcome for picking the award symbol 122 in FIG. 4. It should be appreciated that the sub-game may be any suitable game.

Referring to FIG. 5B, another example of a sub-game is illustrated where the sub-game includes a plurality of reels 142 that are displayed to the player. The reels include award symbols 143. In addition, three paylines 142a, 142b and 142e are associated with the reels. The spins obtained by the player for picking the award symbol 122 in FIG. 4 are indicated in the spins remaining display 116a. Similarly, the multiplier associated with the award symbol 122 is displayed in multiplier display 117a. In this example, the player spins the reels 142 and obtains an award in each spin. The awards are based on winning combinations of symbols indicated on the reels. Any awards obtained by the player are multiplied by the multiplier indicated in multiplier display 117a and then added or transferred to the total award display 118a. The player spins the reels for the number of spins indicated in the spins remaining display 116a. When the player does not have any spins remaining, the player receives the total award indicated in the total award display 118a. Therefore, in FIGS. 5A and 5B, the player receives an outcome, which may be any suitable value or no value, and returns to the primary game.

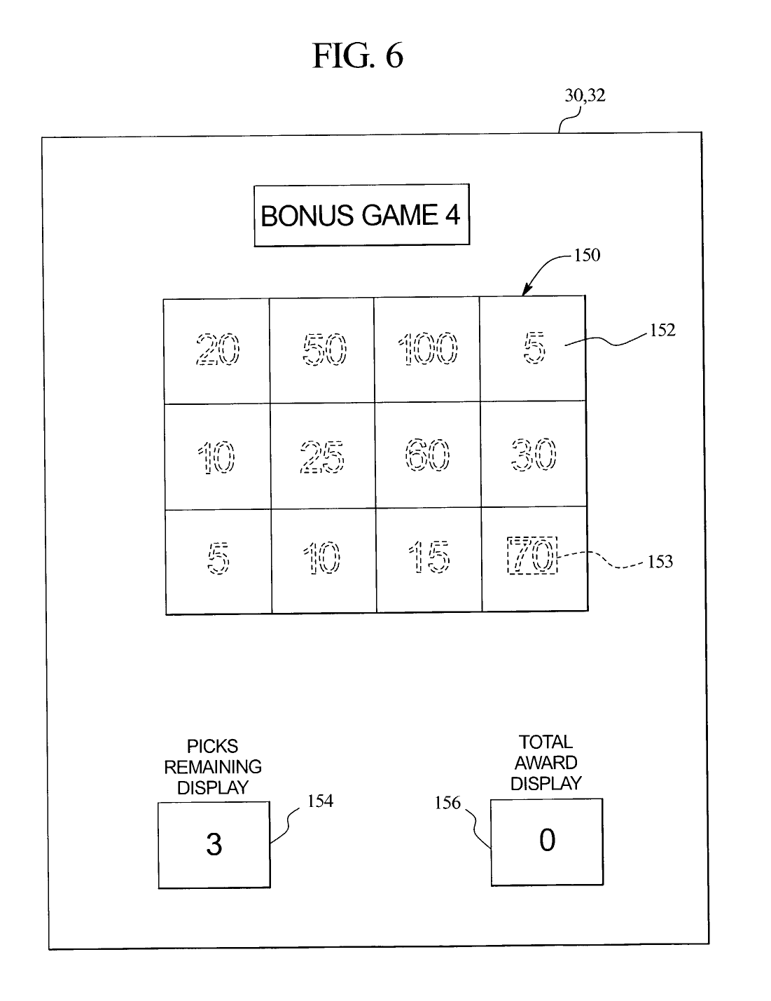

Referring back to FIG. 4, if the player picks the indicated award opportunity that includes the bonus game symbol referring to BONUS GAME 4 (120), the picked bonus game is initiated by the gaming device. In FIG. 6, BONUS GAME 4 is displayed to the player when the player picks the indicated award opportunity having the bonus game symbol 120. It should be appreciated that BONUS GAME 4 may be any type of bonus game desired by the game implementor. In this example, BONUS GAME 4 is a bonus game that displays a plurality of selections 150 to the player. Each selection 152 in the plurality of selections 150 includes an award 153. The awards 153 are initially masked or hidden from the player. Once the player picks a selection 152, the associated award 153 is revealed and provided to the player. The player may be provided with one or more picks from the plurality of selections as indicated by the picks remaining display 154. The player picks selections from the plurality of selections 150 until the player does not have any picks remaining. The player then receives the total accumulated award as indicated in the total award display 156. The total award or outcome which results from BONUS GAME 4 is provided to the player and the player returns to the primary game.

As described above, the average expected value of the outcomes associated with the award opportunities are approximately equal. Thus, in FIG. 4, the outcomes which result from the award opportunity in the sub-game 122 and the BONUS GAME 4 (120) are approximately equal. If the player receives an outcome having a value of one hundred by selecting the award symbol 122, then the average expected value of the outcome which results from the bonus game associated with the bonus game symbol 120 will be approximately equal to one hundred. In another embodiment the outcomes which result from the award opportunities produce different average expected values.

In one embodiment, the award opportunities are associated with a probability of being indicated by the indicator 112. Therefore, the probability of one group or pair of award opportunities being indicated by the indicator 112 is greater than another group or pair of award opportunities being indicated by the indicator. In another embodiment, the award opportunities which produce outcomes with greater average expected values such as the progressive award and the award opportunity having the progressive number of free spins, are associated with probabilities of being indicated. In this embodiment, the probability of the award opportunities which produce outcomes with greater average expected values, such as the progressive award and the award opportunity having the progressive number of free spins, being indicated is less than the probability of any other group or pair of award opportunities being indicated by the indicator.

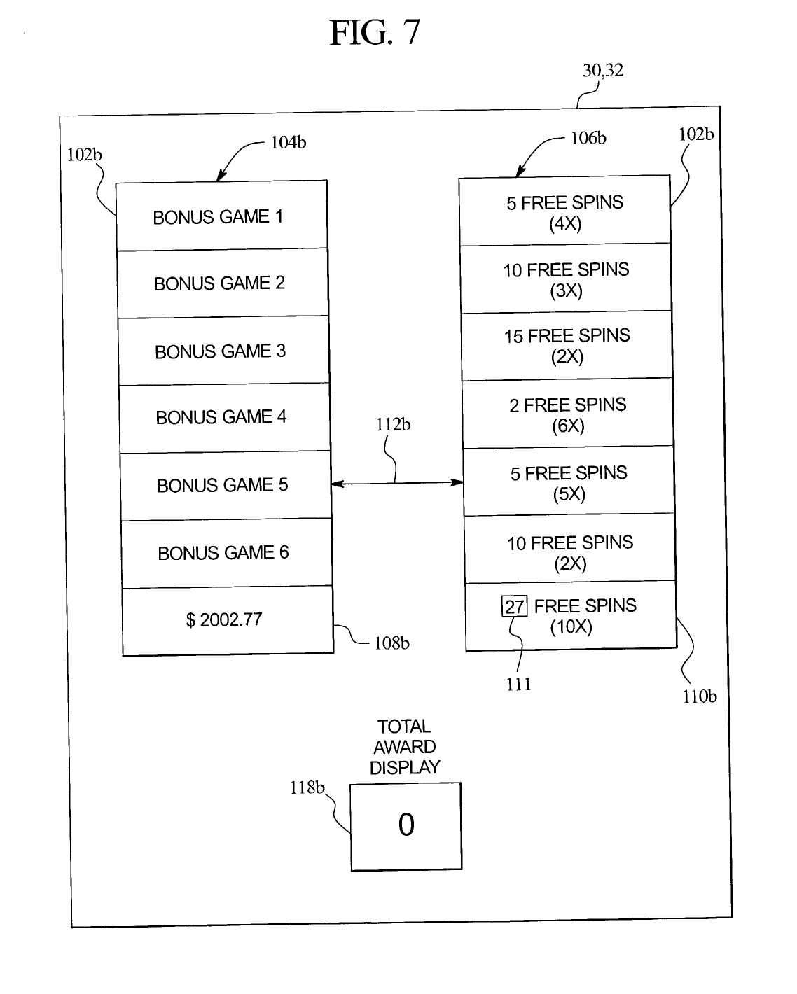

Referring now to FIG. 7, an alternative embodiment of the present invention is illustrated where the bonus game includes groups of award opportunities positioned in two columns 104b and 106b having several sections 102b. In column 104b, the sections 102b include several award opportunities wherein each award opportunity in column 104b produces an outcome based on a particular bonus game. Additionally, a progressive award 108b is associated with one of the sections in column 104b. In column 106b, several award opportunities 110b are associated with the sections 102b. Each award opportunity 110b in column 106b produces an outcome that is based on an opportunity in a sub-game. The player receives a number of free spins and a multiplier to use in the sub-game. One number of free spins is a progressive number of free spins 111. It should be appreciated that the outcomes may be based on any type of awards or games as desired by the game implementor. Each of the groups of related award opportunities includes one of the award opportunities in column 104b and one of the award opportunities in column 106b.

In FIG. 7, the indicator 112b simultaneously indicates one group which includes one of the sections in column 104b and one of the sections in 106b. In another embodiment, one or more indicators 112b separately indicate one of the groups including sections in columns 104b and 106b. The sections may be indicated simultaneously or at different times in the game as long as the player is able to choose from at least two related award opportunities in one or more of the groups. The total award display 118b indicates the total value of the outcomes which result from the award opportunity picked by the player in the game. The player obtains or receives the total award displayed in the total award display 118b when the game ends.

In an alternative embodiment, the present invention is employed as a primary game in a gaming device. In one embodiment of a primary game, a limited number of groups of award opportunities are displayed to the player. In this embodiment, the player may or may not obtain an award in the primary game. The award opportunities include several pairs of bonus games. The indicator indicates one group of award opportunities or two of the related bonus games. Then, the player picks one of the bonus games in the indicated group to receive the outcome, if any, associated with the picked bonus game. In a further alternative embodiment, a probability of being indicated is associated with the groups of award opportunities such that the probability of one group or pair of award opportunities having bonus games being indicated is less than the probabilities of other groups or pairs of award opportunities being indicated.

It should be understood that various changes and modifications to the presently preferred embodiments described herein will be apparent to those skilled in the art. Such changes and modifications can be made without departing from the spirit and scope of the present invention and without diminishing its intended advantages. It is therefore intended that such changes and modifications be covered by the appended claims.

The invention is claimed as follows:

1. A gaming device comprising:
a plurality of groups of award opportunities;
at least two related award opportunities in each of the groups;
a plurality of outcomes associated with the award opportunities;
an indicator adapted to simultaneously indicate at least two of the award opportunities in one of the groups; and
a processor operable to cause the indicator to indicate at least two of the award opportunities in a randomly selected group, enable a player to choose one of the indicated award opportunities and provide the player with an outcome resulting from the indicated award opportunity picked by the player.

2. The gaming device of claim 1, wherein the average expected values of the outcomes resulting from the related award opportunities in at least one group are approximately equal.

3. The gaming device of claim 1, wherein the average expected values of the outcomes resulting from the related award opportunities in at least one group are different.

4. The gaming device of claim 3, which includes a progressive award, wherein the difference between the obtained value of the outcome associated with the award opportunity picked by the player in said group and the average expected value of the outcome associated with said award opportunity in said group is added to the progressive award when said obtained value is less than said average expected value.

5. The gaming device of claim 3, which includes a progressive award, wherein the difference between the obtained value of the outcome associated with the award opportunity picked by the player in said group and at least one of the average expected values of the outcomes associated with the award opportunities in said group is added to the progressive award when said obtained value is less than said average expected value or values.

6. The gaming device of claim 1, wherein at least one of the award opportunities in at least one group includes a bonus event.

7. The gaming device of claim 1, wherein at least one of the award opportunities in a plurality of groups includes a bonus event.

8. The gaming device of claim 1, wherein at least one of the award opportunities in at least one group includes a number of free activations of another game in the gaming device.

9. The gaming device of claim 1, wherein at least one of the award opportunities in a plurality of groups includes a number of free activations of another game in the gaming device.

10. The gaming device of claim 1, wherein at least one of the award opportunities in at least one group includes a number of free activations of another game of the gaming device and a multiplier.

11. The gaming device of claim 1, wherein at least one of the award opportunities in a plurality of groups including a number of free activations of another game of the gaming device and a multiplier.

12. The gaming device of claim 1, wherein at least one of the award opportunities in at least one group includes a progressive award.

13. The gaming device of claim 1, wherein at least one of the award opportunities in at least one group includes a progressive number of free activations of another game of the gaming device.

14. The gaming device of claim 1, wherein at least one of the award opportunities in at least one group includes a progressive award and at least one of the award opportunities in at least one group includes a progressive number of free activations of another game of the gaming device.

15. The gaming device of claim 1, wherein at least one of the award opportunities in the plurality of groups includes a bonus event and at least one of the award opportunities in the plurality of groups includes a number of free activations of another game of the gaming device.

16. The gaming device of claim 1, wherein the award opportunities in each group include at least one of a bonus event, a predetermined award, a progressive award, a progressive number of free activations of another game of the gaming device, a randomly determined award, a free activation in a primary game, a free activation in a bonus event, a free game in a primary game, a free game in a bonus event and a multiplier.

17. The gaming device of claim 1, wherein the groups are included on a wheel.

18. The gaming device of claim 17, wherein the related award opportunities associated with the groups are associated with sections on the wheel.

19. The gaming device of claim 1, wherein said indicator includes an illumination device that highlights the related award opportunities to indicate the award opportunities in the groups.

20. The gaming device of claim 1, which includes a probability of being indicated by the indicator associated with each of the groups.

21. The gaming device of claim 20, wherein the probability of being indicated of one group is greater than the probability of being indicated for at least one other group.

22. The gaming device of claim 1, wherein the outcomes associated with the award opportunities in the groups include at least one of the group consisting of: awards, values, free spins, free games, progressive awards, progressive numbers of free spins, multipliers and credits.

23. The gaming device of claim 1, wherein the related award opportunities are positioned opposite to each other.

24. The gaming device of claim 1, wherein the related award opportunities are positioned adjacent to each other in the groups.

25. A gaming device comprising:
a wheel including a plurality of sections;
a plurality of groups of award opportunities associated with said sections on the wheel;
at least two related award opportunities in each of the groups;
a plurality of outcomes associated with the award opportunities;
at least one section indicator; and
a processor operable to cause said section indicator to move to simultaneously indicate the related award opportunities in one of the groups associated with the sections on the wheel, enable a player to select one of the indicated award opportunities and provide the player at least one of the outcomes associated with the award opportunity picked by the player.

26. The gaming device of claim 25, wherein the average expected values of the outcomes associated with the related award opportunities in at least one group are approximately equal.

27. The gaming device of claim 19, wherein the average expected values of the outcomes associated with the related award opportunities in a plurality of groups are approximately equal.

28. The gaming device of claim 25, wherein the average expected values of the outcomes resulting from the related award opportunities in at least one group are different.

29. The gaming device of claim 28, which includes a progressive award, wherein the difference between the obtained value of the outcome associated with the award opportunity picked by the player in said group and the average expected value of the outcome associated with said award opportunity in said group is added to the progressive award when said obtained value is less than said average expected value.

30. The gaming device of claim 28, which includes a progressive award, wherein the difference between the obtained value of the outcome associated with the award opportunity picked by the player in said group and at least one of the average expected values of the outcomes associated with the award opportunities in said group is added to the progressive award when said obtained value is less than said average expected value or values.

31. The gaming device of claim 25, wherein at least one of the award opportunities in at least one group includes a bonus event.

32. The gaming device of claim 25, wherein at least one of the award opportunities in a plurality of groups includes a bonus event.

33. The gaming device of claim 25, wherein at least one of the award opportunities in at least one group includes a number of free activations of another game of the gaming device.

34. The gaming device of claim 25, wherein at least one of the award opportunities in a plurality of groups includes a number of free activations of another game of the gaming device.

35. The gaming device of claim 25, wherein at least one of the award opportunities in at least one group includes a number of free activations of another game of the gaming device and a multiplier.

36. The gaming device of claim 25, wherein at least one of the award opportunities in a plurality of groups includes a number of free activations of another game of the gaming device and a multiplier.

37. The gaming device of claim 25, wherein at least one of the award opportunities in at least one group includes a progressive award.

38. The gaming device of claim 25, wherein at least one of the award opportunities in at least one group includes a progressive number of free activations of another game of the gaming device.

39. The gaming device of claim 25, wherein at least one of the award opportunities in at least one group includes a progressive award and at least one of the award opportunities in at least one group includes a progressive number of free activations of another game of the gaming device.

40. The gaming device of claim 25, wherein at least one of the award opportunities in at least one group includes a bonus event and at least one of the award opportunities in at least one group includes a number of free activations of another game of the gaming device.

41. The gaming device of claim 25, wherein the award opportunities in each group include at least one of: a bonus event, a predetermined award, a progressive award, a progressive number of free activations of another game of the gaming device, a randomly determined award, a free activation in a primary game, a free activation in a bonus event, a free game in a primary game, a free game in a bonus event and a multiplier.

42. The gaming device of claim 25, wherein said indicator includes an illumination device that highlights the sections on the wheel to indicate the related award opportunities in one of the groups.

43. The gaming device of claim 25, which includes a probability of being indicated by the indicator associated with each of the groups.

44. The gaming device of claim 43, wherein the probability of being indicated of one group is greater than the probability of being indicated for at least one other group.

45. The gaming device of claim 25, wherein the outcomes associated with the award opportunities include at least one of the group consisting of: awards, values, free spins, free games, progressive awards, progressive numbers of free spins, multipliers and credits.

46. The gaming device of claim 25, wherein the related award opportunities are positioned in sections opposite to each other on the wheel.

47. The gaming device of claim 25, wherein the related award opportunities are positioned in sections adjacent to each other on the wheel.

48. A gaming device comprising:
a plurality of pairs of related award opportunities;
a plurality of outcomes associated with the award opportunities;
at least one indicator which indicates one of the pairs of related award opportunities; and
a processor operable to cause the indicator to indicate one of the pairs of related award opportunities, enable a player to choose one of the award opportunities in the indicated pair of related award opportunities and provide the player with the outcome associated with the award opportunity picked by the player from the indicated pair.

49. The gaming device of claim 48, wherein the average expected values of the outcomes associated with the award opportunities in at least one pair of award opportunities are approximately equal.

50. The gaming device of claim 48, wherein the average expected values of the outcomes resulting from the related award opportunities in at least one group are different.

51. The gaming device of claim 50, which includes a progressive award, wherein the difference between the obtained value of the outcome associated with the award opportunity picked by the player in said group and the average expected value of the outcome associated with said award opportunity in said group is added to the progressive award when said obtained value is less than said average expected value.

52. The gaming device of claim 50, which includes a progressive award, wherein the difference between the obtained value of the outcome associated with the award opportunity picked by the player in said group and at least one of the average expected values of the outcomes associated with the award opportunities in said group is added to the progressive award when said obtained value is less than said average expected value or values.

53. The gaming device of claim 48, which includes a probability of being indicated by the indicator associated with each of the pairs of related award opportunities.

54. The gaming device of claim 53, wherein the probabilities are inversely related to the average expected values of the outcomes associated with each of the pairs of related award opportunities.

55. The gaming device of claim 53, wherein the probability associated with one of the pairs of award opportunities is greater than the probability of associated with one of the other pairs of award opportunities.

56. The gaming device of claim 48, wherein the related award opportunities in each pair of related award opportunities are positioned opposite to each other.

57. The gaming device of claim 48, wherein the related award opportunities in each pair of related award opportunities are positioned adjacent to each other.

58. A gaming device comprising:
a plurality of pairs of related award opportunities;
a plurality of outcomes associated with the award opportunities;
at least one indicator which indicates the pairs of related award opportunities; and
a processor operable to cause the indicator to indicate one of the pairs of related award opportunities, enable a player to choose one of the award opportunities in one of the indicated pairs of related award opportunities and provides the player with the outcome associated with the award opportunity picked by the player from the indicated pairs.

59. A gaming device comprising:
a plurality of groups of bonus events;
at least two related bonus events in each group;
a plurality of outcomes, at least one of the outcomes associated with each of the bonus events;
at least one indicator which indicates the bonus events in one of the groups; and
a processor operable to cause the indicator to indicate at least two of the bonus events in one of the groups, enable a player to choose one of the indicated bonus events and provide the player with the outcome associated with the bonus event picked by the player.

60. The gaming device of claim 59, which includes a probability of being indicated associated with each of the groups.

61. The gaming device of claim 60, wherein the probability associated with one of the group is greater than the probability associated with another of the groups.

62. The gaming device of claim 59, wherein the average expected values of the outcomes associated with the bonus events in at least one group are approximately equal.

63. The gaming device of claim 59, wherein the average expected values of the outcomes resulting from the related award opportunities in at least one group are different.

64. The gaming device of claim 63, which includes a progressive award, wherein the difference between the obtained value of the outcome associated with the award opportunity picked by the player in said group and the average expected value of the outcome associated with said award opportunity in said group is added to the progressive award when said obtained value is less than said average expected value.

65. The gaming device of claim 63, which includes a progressive award, wherein the difference between the obtained value of the outcome associated with the award opportunity picked by the player in said group and at least one of the average expected values of the outcomes associated with the award opportunities in said group are added to the progressive award when said obtained value is less than said average expected value or values.

66. A gaming device comprising:
a plurality of groups including related award opportunities;
a plurality of outcomes associated with the award opportunities;
an indicator which indicates award opportunities in the groups; and
a processor operable to cause the indicator to indicate at least two of the award opportunities in the groups, enable a player to choose one of the indicated award opportunities and provide the player with any outcomes associated with the indicated award opportunity picked by the player.

67. The gaming device of claim 66, which includes a wheel including a plurality of sections, wherein the sections include the plurality of groups.

68. The gaming device of claim 66, wherein the indicator is a section indicator which indicates the award opportunities in the groups.

69. The gaming device of claim 66, wherein the indicator indicates award opportunities in the same group.

70. The gaming device of claim 66, wherein the indicator indicates award opportunities in different groups.

71. The gaming device of claim 66, which includes a plurality of indicators.

72. The gaming device of claim 71, wherein the indicators indicate award opportunities in the same group.

73. The gaming device of claim 71, wherein the indicators indicate award opportunities in different groups.

74. The gaming device of claim 66, wherein the average expected values of the outcomes associated with the award opportunities in at least one group are approximately equal.

75. The gaming device of claim 66, wherein the average expected values of the outcomes resulting from the related award opportunities in at least one group are different.

76. The gaming device of claim 75, which includes a progressive award, wherein the difference between the obtained value of the outcome associated with the award opportunity picked by the player in said group and the average expected value of the outcome associated with said award opportunity in said group is added to the progressive award when said obtained value is less than said average expected value.

77. The gaming device of claim 75, which includes a progressive award, wherein the difference between the obtained value of the outcome associated with the award opportunity picked by the player in said group and at least one of the average expected values of the outcomes associated with the award opportunities in said group is added to the progressive award when said obtained value is less than said average expected value or values.

78. The gaming device of claim 66, wherein the groups of award opportunities are included on a wheel.

79. The gaming device of claim 78, wherein the related award opportunities are associated with the sections on the wheel.

80. The gaming device of claim 66, wherein said indicator includes an illumination device that highlights the award opportunities to indicate the award opportunities in the groups.

81. A gaming device comprising:
a plurality of bonus events;
a plurality of groups of award opportunities wherein at least one of the award opportunities in each of the groups includes at least one of the bonus events;
a plurality of outcomes, at least one of the outcomes associated with each of the award opportunities;
at least one indicator which indicates the award opportunities in one of the groups; and
a processor operable to cause the indicator to indicate at least two of the award opportunities in one of the groups, enable a player to choose one of the indicated award opportunities and provide the player with the outcome associated with the award opportunity picked by the player.

82. The gaming device of claim 81, which includes a probability of being selected by the processor associated with each of the bonus events wherein the processor selects and associates the bonus events with the award opportunities based on the probabilities.

83. The gaming device of claim 81, wherein the probabilities are different.

84. The gaming device of claim 81, wherein the probabilities change after each pick by the player.

85. The gaming device of claim 81, wherein the probabilities change in each group of award opportunities.

86. The gaming device of claim 81, wherein the probabilities change for each award opportunity.

87. The gaming device of claim 81, wherein the probabilities change for a plurality of award opportunities.

88. A gaming device comprising:
a plurality of groups of bonus events;
a plurality of groups of award opportunities wherein at least one of the award opportunities in each of the groups includes at least one of the bonus events from the groups of bonus events;
a plurality of outcomes, at least one of the outcomes associated with each of the award opportunities;
at least one indicator which indicates the award opportunities in one of the groups; and
a processor operable to cause the indicator to indicate at least two of the award opportunities in one of the groups, enable a player to choose one of the indicated award opportunities and provide the player with the outcome associated with the award opportunity picked by the player.

89. The gaming device of claim 88, which includes a probability of being selected by the processor associated with each of the bonus events, wherein the processor selects and associates the bonus events with the award opportunities based on the probabilities.

90. The gaming device of claim 88, wherein all of the probabilities are different.

91. The gaming device of claim 88, wherein the probabilities associated with at least two of the groups of bonus events are different.

92. The gaming device of claim 88, wherein the probabilities associated with a plurality of the groups of bonus events are different.

93. The gaming device of claim 88, wherein the probabilities associated with all of the groups of bonus events are different.

94. A method for operating a gaming device, said method comprising the steps of:
(a) displaying a plurality of groups, each group including at least two related award opportunities;
(b) randomly selecting one of the groups and simultaneously indicating at least two of the award opportunities in said groups;
(c) enabling the player to select one of the indicated award opportunities; and
(d) providing an outcome associated with the indicated award opportunity picked by the player.

95. The method of claim 94, wherein the plurality of groups are displayed on a wheel including a plurality of sections.

96. The method of claim 95, wherein the award opportunities in each group are associated with sections on the wheel.

97. The method of claim 95, wherein the step of indicating the award opportunities includes moving a section indicator adjacent to the wheel.

98. The method of claim 95, wherein the step of indicating the award opportunities includes moving the wheel and indicating the award opportunities with a section indicator positioned adjacent to the wheel.

99. The method of claim 94, wherein the step of indicating the award opportunities in one of the groups is performed by illuminating the indicated award opportunities with an illumination device.

100. The method of claim 94, wherein the step of determining said group is based on a probability associated with each group.

101. The method of claim 94, wherein the probability associated with one of the groups is greater than the probability associated with at least another one of the groups.

102. The method of claim 94, wherein the indicating step includes indicating oppositely displayed award opportunities.

103. The method of claim 43, wherein the steps (a) to (d) are provided to the player through a data network.

104. The method of claim 103, wherein the data network is an internet.

105. A method of operating a gaming device, the method comprising the steps of:
(a) displaying a plurality of groups on a wheel, each group including at least two related award opportunities;
(b) randomly selecting one of the groups and simultaneously indicating at least two of the award opportunities in one of the groups on the wheel;
(c) enabling the player to select one of the indicated award opportunities; and
(d) providing an outcome associated with the award opportunity picked by the player.

106. The gaming device of claim 105, which includes displaying at least one of the award opportunities in one of the groups opposite to at least one of the other award opportunities in said group.

107. The gaming device of claim 105, wherein the step of indicating the award opportunities on the wheel is performed by illuminating the award opportunities.

108. The method of claim 105, wherein the steps (a) to (d) are provided to the player through a data network.

109. The method of claim 43, wherein the data network is an internet.

110. A method of operating a gaming device, the method comprising the steps of:
(a) displaying a plurality of groups to a player, each group including related award opportunities;
(b) indicating at least two of the related award opportunities in the groups, wherein a plurality of outcomes are associated with each of the award opportunities;
(c) enabling the player to select one of the indicated award opportunities; and
(d) providing the player the outcome associated with the award opportunity picked by the player.

111. The gaming device of claim 110, wherein the step of indicating at least two award opportunities includes indicating award opportunities in different groups.

112. The gaming device of claim 110, wherein the step of indicating at least two award opportunities includes indicating award opportunities in the same group.

113. The method of claim 110, wherein the steps (a) to (d) are provided to the player through a data network.

114. The method of claim 113, wherein the data network is an internet.

115. A method for operating a gaming device, said method comprising the steps of:
(a) displaying a plurality of groups, each group including at least two related award opportunities, at least one of the award opportunities including a bonus event;
(b) randomly selecting and associating a bonus event from a plurality of bonus events to at least one of the award opportunities in each group;
(c) randomly selecting one of the groups and simultaneously indicating at least two of the award opportunities in said groups;
(d) enabling the player to select one of the indicated award opportunities; and
(e) providing an outcome associated with the indicated award opportunity picked by the player.

116. The method of claim 115, which includes the step of associating a probability of being selected by a processor with each of the bonus events wherein the processor selects and associates the bonus events with each of the award opportunities based on the probabilities.

117. The method of claim 116, wherein at least two of the probabilities are different.

118. The method of claim 116, wherein a plurality of the probabilities are different.

119. The method of claim 116, wherein all of the probabilities are different.

120. The method of claim 116, which includes the step of changing the probabilities after each award opportunity is picked by the player.

121. The method of claim 116, which includes the step of changing the probabilities after a plurality of award opportunities are picked by the player.

122. The method of claim 116, which includes the step of changing the probabilities after each award opportunity including one of the bonus events is picked by the player.

123. The method of claim 116, which includes the step of changing the probabilities after a plurality of award opportunities including bonus events are picked by the player.

124. The method of claim 116, which includes a plurality of groups of bonus events.

125. The method of claim 116, wherein the probabilities associated with each of the bonus events in a plurality of the groups are different.

126. The method of claim 116, wherein the probabilities associated with each of the bonus events in each of the groups are different.

127. The method of claim 115, wherein the steps (a) to (e) are provided to the player through a data network.

128. The method of claim 127, wherein the data network is an internet.
